(19) United States
(12) Patent Application Publication
(10) Pub. No.: US 2017/0278449 A1
(43) Pub. Date: Sep. 28, 2017

(54) SHADING CIRCUIT AND DISPLAY PANEL

(71) Applicant: Shenzhen China Star Optoelectronics Technology Co., Ltd., Shenzhen, Guangdong (CN)

(72) Inventors: Xianming ZHANG, Shenzhen, Guangdong (CN); Dan CAO, Shenzhen, Guangdong (CN)

(73) Assignee: Shenzhen China Star Optoelectronics Technology Co., Ltd., Shenzhen, Guangdong (CN)

(21) Appl. No.: 14/905,799

(22) PCT Filed: Dec. 18, 2015
(86) PCT No.: PCT/CN2015/097877

§ 371 Date: Jan. 16, 2016

(30) Foreign Application Priority Data
Nov. 30, 2015 (CN) 201510856823.9

(51) Int. Cl. G09G 3/20

(52) U.S. Cl. CPC G09G 3/2092; G09G 2310/066; G09G 2310/08

(57) ABSTRACT

The invention provides a shading circuit, comprising a shading module, a first electric switch and at least two modulate units; wherein, the shading module is coupled to a first end of the first electric switch to control the first electric switch on or off, a second end of the first electric switch is used to receive voltage signals, the second end of the first electric switch is coupled to the modulate units, nodes between the second end of the first electric switch and the modulate units are used as an output of shading circuit to output shading waveform, and the shading module is further coupled to the modulate units to control the modulate units for modulating the shading waveform so the slope of the shading waveform is a combining slope. Therefore, the waveform on shading of the shading waveform is close to a curve so the displaying efficiencies get better.

### CROSS-REFERENCE TO RELATED APPLICATIONS

This application claims the priority of Chinese Patent Application No. 201510856823.9, entitled “Shading Circuit and Display Panel”, filed on Nov. 30, 2015, the disclosure of which is incorporated herein by reference in its entirety.

### FIELD OF INVENTION

The invention relates to display field, in particular to a shading circuit and a display panel.

### BACKGROUND OF THE INVENTION

Same shading voltage and slope in the same mode and in a specific frame are generally used in display panel driving; if the slope of shading voltage is needed to be varied to change displaying efficiency of display panel, shading resistance will be needed to be changed then. However, the aforementioned method cannot be processed according to the reality to control different shading waveform under different situations to increase displaying efficiency.

### SUMMARY OF THE INVENTION

The invention discloses a shading circuit and a display panel to increase display efficiencies of the display panel.
The invention provides a shading circuit, comprising a shading module, a first electric switch and at least two modulate units; wherein, the shading module is coupled to a first end of the first electric switch to control the first electric switch on or off, a second end of the first electric switch is used to receive voltage signals, the second end of the first electric switch is coupled to the modulate units, nodes between the second end of the first electric switch and the modulate units are used as an output of shading circuit to output shading waveform, and the shading module is further coupled to the modulate units to control the modulate units for modulating the shading waveform so that the slope of the shading waveform is a combining slope.

Wherein, the modulate units comprise a first modulate unit, a second modulate unit and a third modulate unit, the first to the third modulate units connect in parallel between the second end of the first electric switch and ground, and the shading module connects to the first to the third modulate units to control the first to the third modulate units respectively.

Wherein, the first modulate unit comprises a first resistance and a second electric switch, the second modulate unit comprises a second resistance and a third electric switch, the third modulate unit comprises a third electric switch and a fourth electric switch, a controlling end of the second electric switch connects to the shading modulate, a first end of the second electric switch connects to the second end of the first electric switch through the first resistance, a third end of the second electric switch connects to ground, a controlling end of the third electric switch connects to the shading module, a first end of the third electric switch connects to the second end of the first electric switch through the second resistance, a third end of the third electric switch connects to ground, a controlling end of the fourth electric switch connects to the shading module, a first end of the fourth electric switch connects to the second end of the first electric switch through the third resistance, and a third end of the fourth electric switch connects to ground.

Wherein, the first to the fourth electric switches are triodes.

Wherein, the first electric switch is a NMOS triode, the second to the fourth electric switches are PMOS triodes, and the controlling ends, the first ends and the second ends of the first to the fourth electric switches are gates, drains and sources respectively.

The invention further provides a display panel, comprising a circuit substrate, a glass substrate and a shading circuit disposed on the circuit substrate; the shading circuit comprises a shading module, a first electric switch and at least two modulate units, the shading module is coupled to a first end of the first electric switch to control the first electric switch on or off, a second end of the first electric switch is used to receive voltage signals, the second end of the first electric switch is coupled to the modulate units, nodes between the second end of the first electric switch and the modulate units are used as a output end of shading circuit to output shading waveform, and the shading module is further coupled to the modulate units to control the modulate units for modulating the shading waveform so that the slope of the shading waveform is a combining slope.

Wherein, the modulate units comprise a first modulate unit, a second modulate unit and a third modulate units, the first to the third modulate units connect in parallel between the second end of the first electric switch and ground, and the shading module connects to the first to the third modulate units to control the first to the third modulate units respectively.

Wherein, the first modulate unit comprises a first resistance and a second electric switch, the second modulate unit comprises a second resistance and a third electric switch, the third modulate unit comprises a third electric switch and a fourth electric switch, a controlling end of the second electric switch connects to the shading modulate, a first end of the second electric switch connects to the second end of the first electric switch through the first resistance, a third end of the second electric switch connects to ground, a controlling end of the third electric switch connects to the shading module, a first end of the third electric switch connects to the second end of the first electric switch through the second resistance, a third end of the third electric switch connects to ground, a controlling end of the fourth electric switch connects to the shading module, a first end of the fourth electric switch connects to the second end of the first electric switch through the third resistance, and a third end of the fourth electric switch connects to ground.

Wherein, the display panel further comprises a pulse width modulation chip, the shading module and the first electric switch are both disposed inside the pulse width modulation chip, and the modulate units are disposed outside the pulse width modulation chip.

Wherein, a register is disposed inside the pulse width modulation chip, and the register is used to control the modulate units to modulate the shading waveform to make a slope of the shading waveform a combining slope.

The invention provides a shading circuit, comprising a shading module, a first electric switch and at least two modulate units; wherein, the shading module is coupled to a first end of the first electric switch to control the first electric switch on or off, a second end of the first electric switch is used to receive voltage signals, the second end of the first electric switch is coupled to the at least two modulate units, nodes between the second end of the first electric switch and the modulate units are used as an output of shading circuit to output shading waveform, and the shading module is further coupled to the modulate units to control the modulate units for modulating the shading waveform so that the slope of the shading waveform is a combining slope. Therefore, the line of the shading waveform located on the shading is substantially a curve to improve displaying efficiencies of the display panel, and then the displaying efficiencies of display panel is further increasing in the present invention.

### BRIEF DESCRIPTION OF THE DRAWINGS

In order to illustrate the technical proposal of implementations of the present invention or existing technology clearly, with reference to said accompanying drawings, the description of the implementations of the present invention or existing technology are given as following. Obviously, the given accompanying drawings are not only implementations of the present invention so that, the ordinary technicians in this field could get other accompanying drawings in accordance with said accompanying drawings without devoting a creative work.

FIG. 1 shows a diagram of shading circuit for a better embodiment of a first case in the invention.

FIG. 2 shows a schematic of the shading circuit for a better embodiment of the first case in the invention.

FIG. 3 shows a diagram of shading circuit for a better embodiment of a second case in the invention.

### DETAILED DESCRIPTION

With reference to said accompanying drawings, the description of the technical proposal of the implementations of the present invention is given clearly and integrality as following. The given implementations are only part of the implementation to the present invention, but not entire implementations. Based on the implementations of the present invention, all of the other implementations which get without devoting a creative work by the ordinary technicians in this field should be deemed to be within the scope of the present invention.

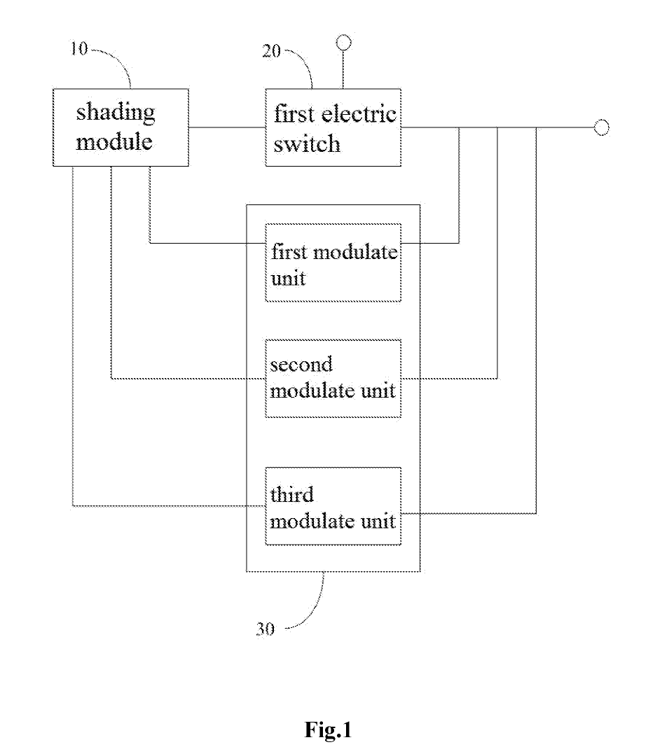

Please refer to FIG. 1, a better embodiment of the first case in the invention provides a shading circuit 100. The shading circuit 100 comprises a shading module 10, a first electric switch 20 and at least two modulate units 30. A second end of the first electric switch 20 is used to receive voltage signals. The second end of the first electric switch 20 is coupled to the modulate units 30. Nodes between the second end of the first electric switch 20 and the modulate units 30 are used as an output of shading circuit 100 to output shading waveform, and the shading module 10 is further coupled to the modulate units 30 to control the modulate units 30 for modulating the shading waveform so that the slope of the shading waveform is a combining slope.

It should be noted that the combining slope is a combination of multiple slopes, the waveform on shading of the shading waveform is close to a curve. Of course, when an amount of the modulate unit 30 accumulates to a certain amount, the curve on shading of the shading waveform is close to a sinusoid so that the displaying efficiencies of display panel get better.

In this embodiment, the shading circuit 100 comprises a shading module 10, a first electric switch 20 and at least two modulate units 30. The shading module 10 is coupled to a first end of the first electric switch 20 to control the first electric switch 20 on or off. A second end of the first electric switch 20 is used to receive voltage signals. The second end of the first electric switch 20 is coupled to the at least two modulate units 30. Nodes between the second end of the first electric switch and the modulate units are used as an output of shading circuit 100 to output shading waveform, and the shading module 10 is further coupled to the modulate units 30 to control the modulate units for modulating the shading waveform so that the slope of the shading waveform is a combining slope. Therefore, the waveform on shading of the shading waveform is close to a curve so that the displaying efficiencies of display panel get better, and then the displaying efficiencies of display panel is further increasing in the present invention.

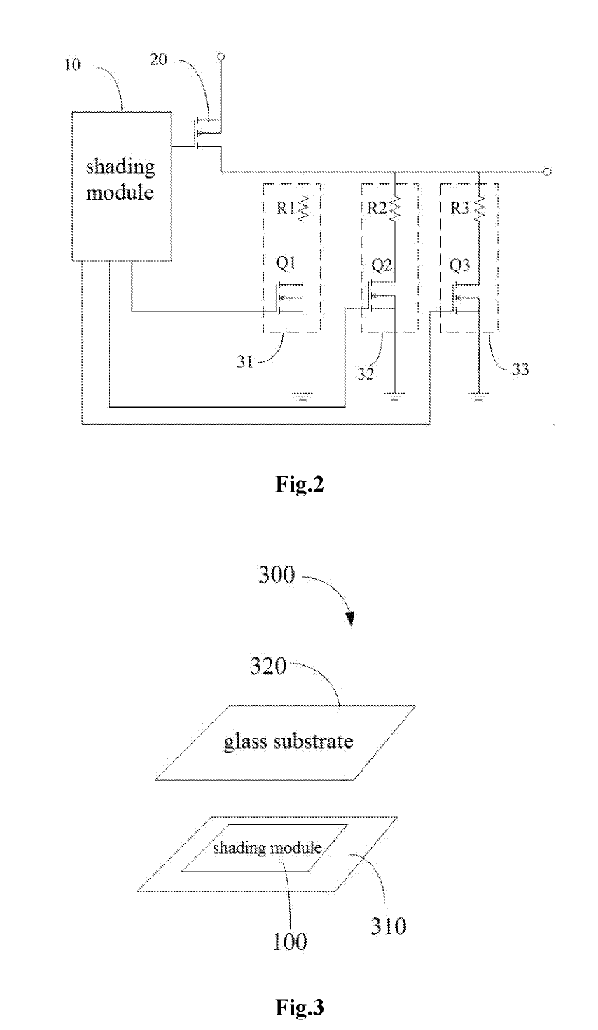

Please refer to FIG. 2, furthermore, the modulate units 30 comprise a first modulate unit 31, a second modulate unit 32 and a third modulate unit 33. The first to the third modulate units 31-33 connect in parallel between the second end of the first electric switch 20 and ground. The shading module 10 connects to the first to the third modulate units 31-33 to control the first to the third modulate units 31-33 respectively.

Particularly, the first modulate unit 31 comprises a first resistance R1 and a second electric switch Q1. The second modulate unit 32 comprises a second resistance R2 and a third electric switch Q2. The third modulate unit 33 comprises a third electric switch R3 and a fourth electric switch Q3. A controlling end of the second electric switch Q1 connects to the shading modulate 10. A first end of the second electric switch Q1 connects to the second end of the first electric switch through the first resistance R1. A third end of the second electric switch Q1 connects to ground. A controlling end of the third electric switch Q2 connects to the shading module 10. A first end of the third electric switch Q2 connects to the second end of the first electric switch 20 through the second resistance R2. A third end of the third electric switch Q2 connects to ground. A controlling end of the fourth electric switch Q3 connects to the shading module 10. A first end of the fourth electric switch Q3 connects to the second end of the first electric switch 20 through the third resistance R3, and a third end of the fourth electric switch Q3 connects to ground. In the present embodiment, all the first to the fourth electric switches 20 and Q1-Q3 are triodes. The first electric switch 20 is a NMOS triode. The second to the fourth electric switches Q1-Q3 are PMOS triodes. The controlling ends, the first ends and the second ends of the first to the fourth electric switches 20 and Q1-Q3 are gates, drains and sources respectively.

In the present embodiment, the module units 30 comprises the first to the third modulate units 31-33. In other embodiments, an amount of the modulate units can be adjusted as required.

Please refer to FIG. 3, the second case of the invention further provides a display panel. A display panel 300 comprises a circuit substrate 310, a glass substrate 320 and a shading circuit disposed on the circuit substrate 310. The shading circuit is the shading circuit 100 of the first case. The shading circuit 100 of the aforementioned first case is described in detail, so no further details are discussed.

In the present embodiment, the display panel 300 comprises the shading circuit 100. The shading circuit 100 comprises a shading module 10, a first electric switch 20 and at least two modulate units 30. The shading module 10 is coupled to a first end of the first electric switch 20 to control the first electric switch 20 on or off. A second end of the first electric switch 20 is used to receive voltage signals. The second end of the first electric switch 20 is coupled to the modulate units 30. Nodes between the second end of the first electric switch 20 and the modulate units are used as a output end of shading circuit 100 to output shading waveform, and the shading module 10 is further coupled to the modulate units 30 to control the modulate units 30 for modulating the shading waveform so that the slope of the shading waveform is a combining slope. Therefore, the waveform on shading of the shading waveform is close to a curve so that the displaying efficiencies of display panel 300 get better, and then the displaying efficiencies of display panel 300 is further increasing in the present invention.

Furthermore, the display panel 300 further comprises a pulse width modulation chip (not shown in the figures), the shading module 10 and the first electric switch 20 are both disposed inside the pulse width modulation chip. The modulate units 30 are disposed outside the pulse width modulation chip.

A register is disposed inside the pulse width modulation chip, and the register is used to control the modulate units 30 to modulate the shading waveform to make a slope of the shading waveform a combining slope.

The disclosed are merely exemplary embodiments of the present invention, but not intended to limit the scope of the present invention. That the people skilled in the art can understand a part of or all of the process of the embodiments, and then equivalent variations can be figured out according to the claims shall fall within the protection scope of the present invention.

What is claimed is:

1. A shading circuit, comprising: a shading module, a first electric switch and at least two modulate units; wherein, the shading module is coupled to a first end of the first electric switch to control the first electric switch turning on or turning off, a second end of the first electric switch is used to receive voltage signals, the second end of the first electric switch is coupled to the at least two modulate units, nodes between the second end of the first electric switch and the modulate units are used as an output of shading circuit to output shading waveform, and the shading module is further coupled to the modulate units to control the modulate units for modulating the shading waveform so that the slope of the shading waveform is a combining slope.

2. The shading circuit according to claim 1, wherein, the modulate units comprise a first modulate unit, a second modulate unit and a third modulate unit, the first to the third modulate units connect in parallel between the second end of the first electric switch and ground, and the shading module connects to the first to the third modulate units to control the first to the third modulate units respectively.

3. The shading circuit according to claim 2, wherein, the first modulate unit comprises a first resistance and a second electric switch, the second modulate unit comprises a second resistance and a third electric switch, the third modulate unit comprises a third electric switch and a fourth electric switch, a controlling end of the second electric switch connects to the shading modulate, a first end of the second electric switch connects to the second end of the first electric switch through the first resistance, a third end of the second electric switch connects to ground, a controlling end of the third electric switch connects to the shading module, a first end of the third electric switch connects to the second end of the first electric switch through the second resistance, a third end of the third electric switch connects to ground, a controlling end of the fourth electric switch connects to the shading module, a first end of the fourth electric switch connects to the second end of the first electric switch through the third resistance, and a third end of the fourth electric switch connects to ground.

4. The shading circuit according to claim 3, wherein, the first to the fourth electric switches are triodes.

5. The shading circuit according to claim 4, wherein, the first electric switch is a NMOS triode, the second to the fourth electric switches are PMOS triodes, and the controlling ends, the first ends and the second ends of the first to the fourth electric switches are gates, drains and sources respectively.

6. A display panel comprises a circuit substrate, a glass substrate and a shading circuit disposed on the circuit substrate; wherein, the shading circuit comprises a shading module, a first electric switch and at least two modulate units, the shading module is coupled to a first end of the first electric switch to control turning on or turning off of the first electric switch, a second end of the first electric switch is used to receive voltage signals, the second end of the first electric switch is coupled to the modulate units, nodes between the second end of the first electric switch and the modulate units are used as a output end of shading circuit to output shading waveform, and the shading module is further coupled to the modulate units to control the modulate units for modulating the shading waveform so that the slope of the shading waveform is a combining slope.

7. The display panel according to claim 6, wherein, the modulate units comprise a first modulate unit, a second modulate unit and a third modulate units, the first to the third modulate units connect in parallel between the second end of the first electric switch and ground, and the shading module connects to the first to the third modulate units to control the first to the third modulate units respectively.

8. The display panel according to claim 7, wherein, the first modulate unit comprises a first resistance and a second electric switch, the second modulate unit comprises a second resistance and a third electric switch, the third modulate unit comprises a third electric switch and a fourth electric switch, a controlling end of the second electric switch connects to the shading modulate, a first end of the second electric switch connects to the second end of the first electric switch through the first resistance, a third end of the second electric switch connects to ground, a controlling end of the third electric switch connects to the shading module, a first end of the third electric switch connects to the second end of the first electric switch through the second resistance, a third end of the third electric switch connects to ground, a controlling end of the fourth electric switch connects to the shading module, a first end of the fourth electric switch connects to the second end of the first electric switch through the third resistance, and a third end of the fourth electric switch connects to ground.

9. The display panel according to claim 6, wherein, the display panel further comprises a pulse width modulation chip, the shading module and the first electric switch are both disposed inside the pulse width modulation chip, and the modulate units are disposed outside the pulse width modulation chip.

10. The display panel according to claim 7, wherein, a register is disposed inside the pulse width modulation chip, and the register is used to control the modulate units to modulate the shading waveform to make a slope of the shading waveform a combining slope.
